(19) United States
(12) Patent Application Publication
(10) Pub. No.: US 2010/0281044 A1
(43) Pub. Date: Nov. 4, 2010

(54) METHOD AND SYSTEM FOR CREATING A PROFILED SOCIAL NETWORK

(76) Inventors: Ajay GUPTA, Bangalore (IN); Somnath Banerjee, Bangalore (IN); Krishnan Ramanathan, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/495,825

(22) Filed: Jul. 1, 2009

(30) Foreign Application Priority Data
Apr. 29, 2009 (IN) 987/CHE/2009

(51) Int. Cl. G06F 17/30; G06F 15/16

(52) U.S. Cl. 707/765; 709/204; 709/223; 709/224; 707/E17.108; 707/748

(57) ABSTRACT

Presented is a computer implemented method and system for creating a profiled social network. The method includes mapping at least one identity to each node in the plurality of nodes, defining a profile for each node in the plurality of nodes, identifying a relationship between the at least two nodes in the plurality of nodes, defining a profile for the relationship between the at least two nodes in the plurality of nodes, and forming a collection of profiles defined for all relationships between the plurality of nodes.

### RELATED APPLICATIONS

Benefit is claimed under 35 U.S.C. 119(a)-(d) to Foreign application Serial No. 987/CHE/2009 entitled “METHOD AND SYSTEM FOR CREATING A PROFILED SOCIAL NETWORK” by Hewlett-Packard Development Company, L.P., filed on 29 Apr., 2009, which is herein incorporated in its entirety by reference for all purposes.

### BACKGROUND

Social networks satisfy the basic human need to connect and share with other fellow human beings. They allow people to build communities around their areas of interests and provide a great way to enhance knowledge. However, social networks need not be limited to people or individuals. They may include other social entities such as companies, institutions, businesses, committees or towns. A social network is the sum total of interactions and relationships between these entities. To provide an example, a group of CEOs from diverse companies who regularly interact over a game of golf form a social network. Their interactions with each other constitute social relationships. It is commonly accepted that such social interactions go a long way in exchange of ideas and information thus helping individuals and businesses perform better. With the advent of internet, various online web services are now available that further promotes and aids such interactions. LinkedIn, Orkut and Friendster are a few examples of online social network web services.

### BRIEF DESCRIPTION OF THE DRAWINGS

For a better understanding of the invention, embodiments will now be described, purely by way of example, with reference to the accompanying drawings, in which:

FIG. 1 shows a conceptual illustration of a social network according to an embodiment.

FIG. 2 shows a flow diagram of a method for creating a profiled social network according to an embodiment.

FIG. 3 shows a flow diagram of further steps of the method depicted in FIG. 2 to define at least one profile for a relationship between at least two nodes in a plurality of nodes according to an embodiment.

FIG. 4 shows a flow diagram of a method for searching a profiled social network created corresponding to the method in FIG. 1 and FIG. 2.

FIG. 5 shows an exemplary social network system on which embodiments of the invention may be implemented.

### DETAILED DESCRIPTION OF THE INVENTION

Online web services provide a simple way for people to build and maintain a social network. In most cases, a user is simply required to create an online account providing basic information about himself or herself. Once an account has been created, a user has the option of inviting other users to join his or her network. Alternatively, the user could also become a member of other user networks. There is usually no limit on the number of members a network may have.

One of the main limitations with the present social network web services is that they tend to degenerate in quality or usefulness. Since actual user interaction is never evaluated and no distinction is made between different types of user relationships, the real worth of a social network deteriorates over a period of time. Another issue with current social networks is their weakness in privacy handling. The social network and the profile of people are usually kept in a centralized place leading to concerns about privacy. People would ideally like to keep their social network and profile information private. Present social networks do not address this requirement.

The present invention describes the creation of a profiled social network that addresses the problems, such as, but not limited to, those described above.

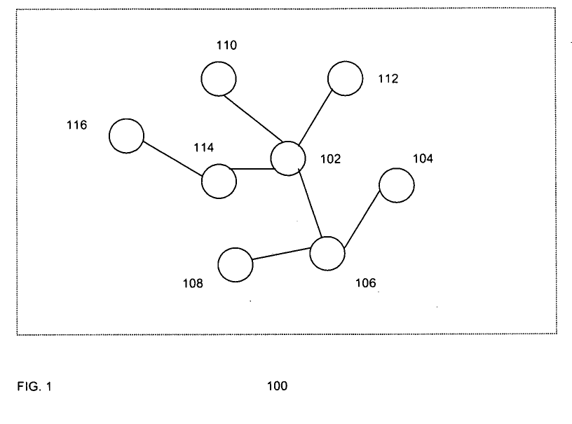

FIG. 1 shows a conceptual illustration of a social network 100 according to an embodiment.

A social network may be represented in the form of a collection of nodes and ties. The nodes represent people or other social entities in the network and the ties symbolize the relationships between the nodes. In the present embodiment, the social network 100 comprises nodes (102 to 116) and ties (represented by straight connecting lines in FIG. 1). A node may be connected to other nodes in the network. For example, in FIG. 1, node 102 is connected to nodes 106, 110, 112 and 114. Further, a node 102 may be directly connected to other nodes (106, 110, 112 and 114) or indirectly connected through one of the other connected nodes. In case of node 102, it is indirectly connected to node 108 through node 106. There is potentially no limit to the number of nodes a node may connect to in a social network. Further, the number of nodes connected to a particular node may wary over a period of time. Also, a node may not be limited to one social network. A node may exist and participate in a plurality of social networks. It would be appreciated that the embodiments of the present invention described herein are not limited to a single social network. It may be implemented in multiple social networks. Further, the present invention is also not limited to a particular type or structure of a social network.

In an embodiment, nodes 102 to 116 may represent people or users. The people may be, for example, users of an on-line computer service, such as a social networking site, a chat service, a bulletin board, or any other group of people. Further, the plurality of nodes in the network may include a person, a location, a company, a business, a community and/or an entity.

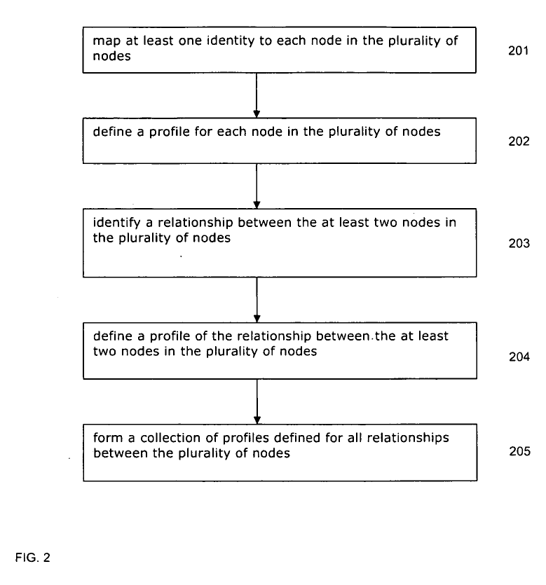

FIG. 2 shows a flow diagram of a method for creating a profiled social network according to an embodiment.

In an embodiment, each person, in a social network having a plurality of nodes, is described as a node n belonging to type N. A node may have multiple identities {i1, . . . ,iN} in different communication networks. In step 201, at least one identity is mapped to each node in the plurality of nodes in a social network. For example, a person might be known with several email ids on different email or messaging systems (such as Yahoo, Gmail, etc), have multiple phone numbers (such as landline and mobile), and may use different login ids for different bulletin boards and chat rooms. Therefore, an identity may include, such as, but not limited to, an email address, a phone number, a chat ID and a login ID. The multiple identities are mapped to the person (node n) having these identities.

Further, the mapping of different identities to a person (node) may be performed on the client side of a computer system and with user participation (i.e. with an input received from the person (node)). In another embodiment, at least one identity may be from at least one other social network.

In step 202, a profile for each node in the plurality of nodes is defined. For example, each node n may have a profile p(n) belonging to type P. There may be many different representations of P. In an embodiment, the representation may be in the form of a term vector. In simple terminology, a term vector is a list of the document's terms and their number of occurrences' in that document. In other embodiments, other forms of representations such as Wiki concepts, DMOZ hierarchy, nodes on specific ontologies created for specialized domains may also be used. The creation of a profiled social network only requires that a representation for the profile of node is selected.

In step 203, a relationship between the at least two nodes in the plurality of nodes is identified. Relationship between two nodes, for example, ni and nj, may be expressed as r(ni,nj) belonging to R. To illustrate, in case of an email messaging system, a person (node ni) may exchange emails with another person (node nj). The exchange of email communication indicates existence of a relationship between the two nodes (ni and nj). It would be appreciated that there could be different kinds of relationships between the nodes. For example, a node may exchange emails with one node and chat with another node. The aspects of the present invention described herein are not limited to identifying any particular kind of relationship between two nodes and include all possible relationships that may exist between the two. In functional terms, at this stage, the social network (R(ni)) of a node ni, may be defined as {nj|there exists r(ni,nj)}.

In step 204, a profile of the relationship between the at least two nodes in the plurality of nodes is defined. A profile for the relationship may be expressed as pr(ni, nj)) belonging to the profile type P. A profile of the relationship between two nodes (ni and nj) is defined once a relationship between the two nodes has been identified.

In step 205, a collection of profiles defined for all relationships between the plurality of nodes is formed. In other words, a profiled social network PR(ni) may be defined as the collection of pr(ni, nj) for all nodes in R(ni).

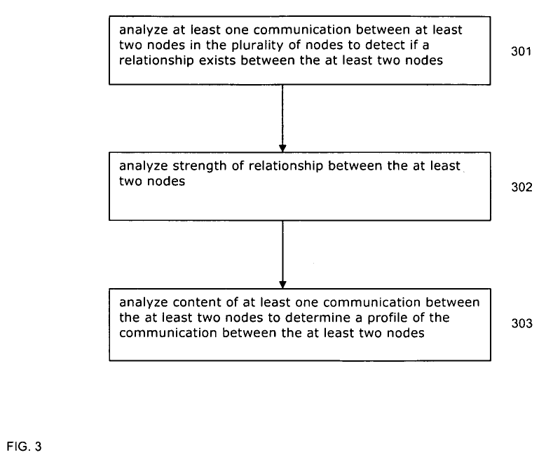

FIG. 3 shows a flow diagram of further steps of the method depicted in FIG. 2 to define at least one profile for a relationship between at least two nodes in a plurality of nodes according to an embodiment.

In step 301, at least one communication between at least two nodes in the plurality of nodes of a social network is analyzed to detect if a relationship exists between the at least two nodes. In an embodiment, any communication between two nodes (say, ni and nj) is analyzed to detect if a relationship exists between the two nodes. For example, in case of a social networking system, a person (node ni) may exchange emails, chat messages or even phone calls with another person (node nj). All such communication exchanges indicate existence of a relationship between the two nodes (ni and nj). It would be appreciated that for each communication channel, a node (ni) will be interacting with a set of nodes {nj, etc} using a particular identity set(s), which has already been mapped to the node (ni) in step 201 of FIG. 2.

In step 302, strength of relationship between the at least two nodes is analyzed. The strength of a relationship between two nodes may be indicated by the nature and frequency of communication. Numerous mechanisms may be used to analyze the strength of relationship between two nodes. To illustrate, phone calls during office hours may indicate professional conversation as opposed to out of office hour calls, a greater frequency of calls between two numbers may indicate a close relationship and an exchange of communication during holidays or festivals may indicate a degree of proximity between two nodes. Further mechanisms, such as, but not limited to, may include, use of co-authors of scientific and technical papers, citations in web pages, use of org charts and use of messages exchanged between members of a bulletin board. All of these methods may be used either individually or in combination to indicate strength of relationship between two nodes

In step 303, content of at least one communication between the at least two nodes is analyzed to determine a profile of the communication between the at least two nodes. Again, numerous mechanisms may be used to analyze the content of communication between two nodes. Some of the mechanisms include analysis of email messages, chat communication, bulletin board messages etc. The text based messages (for example, content of an email, an instant message, a SMS, etc.) may be turned into term vectors, Wiki concepts or DMOZ hierarchy by applying various text analysis techniques. For other communication types, such as voice call, associate material, for example, minutes of meeting, or follow-up emails may be used to analyze the content for creating a profile of the association. Since the profile of a relationship is independent of nature of communication, once strength of relationship has been derived, even small amount of information gathered from an occasional textual interchange may be used to provide content to the profile of the relationship.

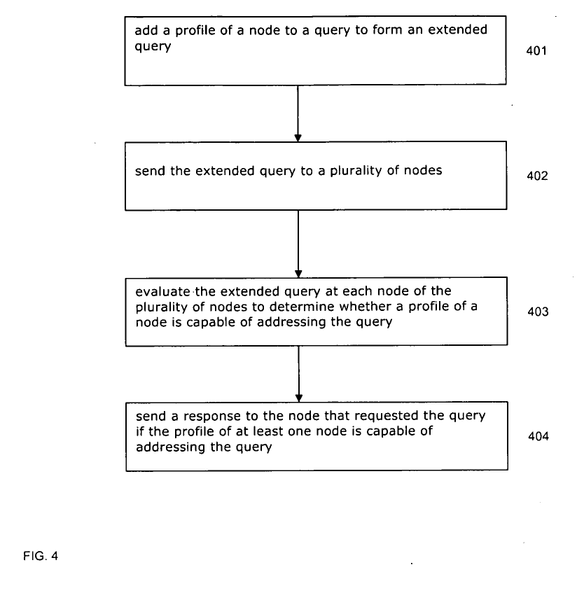

FIG. 4 shows a flow diagram of a method for searching a profiled social network created corresponding to the method in FIG. 1 and FIG. 2.

In step 401, a profile of a node is added to a query to form an extended query, wherein the query is requested by the node. In an embodiment, a query q may relate to a topic t. In step 401, the profile of the node asking the query is added to the query q. To illustrate, in case of a social networking system, a person (node ni) may like to query, “Have you read book ABC?”, to other nodes of the social networking system. In this case, the profile of the node (ni) would be added to the query, “Have you read book ABC?”, to form an extended query (q+p′). In another embodiment, the profile of a node may be determined based on certain criteria, such as, what the person (node ni) is willing to share and what is relevant to the topic of q. The objective of the query is to not to answer the query itself but to determine the persons (nodes) who are most relevant to answer the query.

In step 402, the extended query is sent to a plurality of nodes, wherein the plurality of nodes has at least one relationship with the node requesting the query. To illustrate with the example provided above, the query, “Have you read book ABC?”, would be sent to those nodes which has at least one relationship with the node ni. In functional terms, extended query (q+p′) is sent to those nodes (such as, nj) where p(r(ni,nj)) subsumes p′.

In step 403, the extended query is evaluated at each node of the plurality of nodes to determine whether a profile of a node is capable of addressing the query. The query, “Have you read book ABC?”, is evaluated at each node of the social networking system to determine if there is some related content in the profile of a node that can address the query. It would be appreciated that a query may also be more generic such as “I want to know treatment for a disease XYZ”. In such cases, other profiles may be assessed for concepts related to the disease XYZ and chosen for responding.

In step 404, a response is sent to the node that requested query if the profile of at least one node is capable of addressing the query. If in response to the query, “Have you read book ABC?”, the profile of a node is capable of providing an answer, the response is sent to the requesting node. There may be user control on whether the response should be automatically sent or intercepted by the person (node).

It would be appreciated that a query may also get propagated from an original receiving node to its own further connected set of nodes. In this way, the query may travel to the next level of social network. The response generated by such second level search may be aggregated and presented to the receiving node.

In another embodiment, the response node is determined by the presence of the same profile concept or word in the profiles of the querying node and response node. In a further embodiment, the profiles may be expanded using a spreading activation algorithm to encompass similar concepts in the two nodes. In yet another embodiment, the similarity may be measured at an overall profile level and not a concept level. In this case, various similarity metrics may be used to measure the similarity of the profiles at the two nodes, for example, the Jaccard similarity measure.

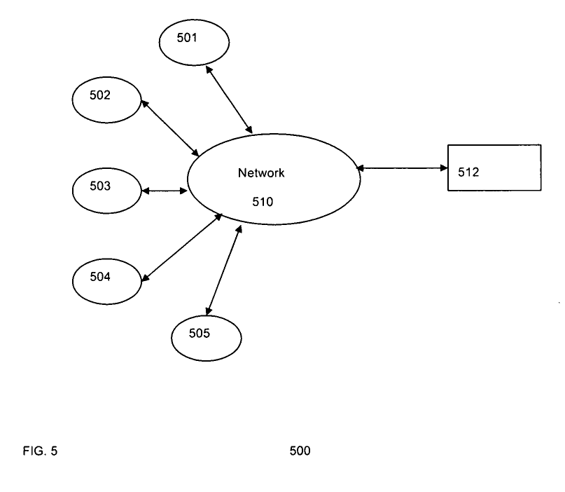

FIG. 5 shows an exemplary social network system 500 on which embodiments of the invention may be implemented.

Users (nodes) 501, 502, 503, 504 and 505 are coupled to a social network provider 512 via a communications network 510. The users 501, 502, 503, 504 and 505, may include various types of users, including a person, a location, a company, a business, a community and/or an entity. The users 501, 502, 503, 504 and 505, may connect to the communications network 510 through various user devices such as a computer system, a personal digital assistant (PDA), a mobile phone, a pager, a walkie talkie, a smart phone, a laptop computer, etc. In various embodiments, the communications network 504 may include a local area network (LAN), a wide area network (WAN), the Internet, etc. The social network provider 512 is an entity that provides social networking services, chat services, bulletin board services, etc. to its users.

Some of the advantages provided by the above described embodiments for creating a profiled social network may be summarized as follows:

The embodiment described provides one of the simplest ways for identifying an interested party in one's social network. For example, if a movie review is to be recommended, the topic of the article can be matched with the profile of different links, and user is prompted if they would like to recommend to those where the relationship profile matched. Further, since the social network is profiled, it is possible to determine which kind of queries, recommendation, etc can be propagated along the link. This would reduce the spam and focus the context. Furthermore, since the profile of the relationship along with the profile of the person is maintained on the client side of the computer system there is no additional privacy exposure.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A computer implemented method for creating a profiled social network having a plurality of nodes, the method comprising:
mapping at least one identity to each node in the plurality of nodes;
defining a profile for each node in the plurality of nodes;
identifying a relationship between the at least two nodes in the plurality of nodes;
defining a profile of the relationship between the at least two nodes in the plurality of nodes; and
forming a collection of profiles defined for all relationships between the plurality of nodes.

2. The method of claim 1, further comprising:
analyzing at least one communication between at least two nodes in the plurality of nodes to detect if a relationship exists between the at least two nodes;
analyzing strength of relationship between the at least two nodes; and
analyzing content of at least one communication between the at least two nodes to determine a profile of the communication between the at least two nodes.

3. The method of claim 2, wherein the strength of the relationship is indicated by nature of communication between the at least two nodes.

4. The method of claim 2, wherein the strength of the relationship is indicated by frequency of communication between the at least two nodes.

5. The method of claim 1, wherein the plurality of nodes in the network include at least one of a person, a location, a company, a business, a community and an entity.

6. The method of claim 1, wherein the at least one identity includes an email address, a phone number, a chat ID and a login ID.

7. The method of claim 1, wherein the at least one identity is from at least one other social network.

8. The method of claim 1, wherein the at least one identity is mapped to a node on a client computer system.

9. The method of claim 1, wherein the at least one identity is mapped to a node with an input received from the node.

10. A method for searching profiled social network of claim 1, the method comprising:
adding a profile of a node to a query to form an extended query, wherein the query is requested by the node;
sending the extended query to a plurality of nodes, wherein the plurality of nodes has at least one relationship with the node requesting the query;
evaluating the extended query at each node of the plurality of nodes to determine whether a profile of a node is capable of addressing the query; and
sending a response to the node that requested the query if the profile of at least one node is capable of addressing the query.

11. A method of claim 10, wherein evaluating the extended query at each node of the plurality of nodes to determine whether a profile of a node is capable of addressing the query includes further sending the query to a set of nodes connected to each node of the plurality of nodes.

12. A system for creating a profiled social network, the system comprising:
means for mapping at least one identity to each node in the plurality of nodes;
means for defining a profile for each node in the plurality of nodes;
means for identifying a relationship between the at least two nodes in the plurality of nodes;
means for defining a profile for the relationship between the at least two nodes in the plurality of nodes; and
means for forming a collection of profiles defined for all relationships between the plurality of nodes.

13. A system of claim 12, further comprising:
means for analyzing at least one communication between at least two nodes in the plurality of nodes to detect if a relationship exists between the at least two nodes;
means for analyzing strength of relationship between the at least two nodes; and
means for analyzing content of at least one communication between the at least two nodes to determine a profile of the communication between the at least two nodes.

14. A computer program comprising computer program means adapted to perform all of the steps of claim 1 when said program is run on a computer.

15. A computer program according to claim 14 embodied on a computer readable medium.
